(19) United States
(12) Patent Application Publication
(10) Pub. No.: US 2021/0372799 A1
(43) Pub. Date: Dec. 2, 2021

(54) METHOD AND SYSTEM FOR EVOLVING A CONTEXT COGNITIVE CARTOGRAPHIC GRID FOR A MAP

(71) Applicant: DISTA INC., Princeton, NJ (US)

(72) Inventors: Shishir GOKHALE, Pune (IN); Deepak GARG, Pune (IN)

(21) Appl. No.: 17/404,635

(22) Filed: Aug. 17, 2021

Related U.S. Application Data
(63) Continuation of application No. 16/019,517, filed on Jun. 26, 2018.
(60) Provisional application No. 62/527,067, filed on Jun. 30, 2017.

(51) Int. Cl. G01C 21/32; G01C 21/34; G06N 20/00; G06F 16/29

(52) U.S. Cl. CPC G01C 21/32; G06F 16/29; G06N 20/00; G01C 21/3492

(57) ABSTRACT

Disclosed are systems (100) and (400) and a method (200) of evolution of a cartographic grid using map information. More specifically the evolution of context cognitive cartographic grid uses context cognitive data and historical data. For an identified reference geolocation on the map, various routes emanating from the reference geolocation are identified and then using pre-defined context parameters, a second geolocation is selected or updated. The process is repeated until all the possible routes associated with the identified reference geo-location are traversed. Subsequently, a convex grid is created using all the geolocations found, to evolve the context cognitive cartographic grid.

### CROSS-REFERENCE TO RELATED APPLICATIONS

The present disclosure claims priority from the provisional U.S. patent application No. 62/527,067 filed on Jun. 30, 2017, which is incorporated in its entirety for all purposes.

### FIELD OF THE INVENTION

The title relates to the field of evolution of a cartographic grid using map information. More specifically the evolution of context cognitive cartographic grid uses context cognitive data and historical data.

### BACKGROUND OF THE INVENTION

In the Prior Art, various applications using maps have been described. Some exemplary references are given as follows: U.S. Pat. No. 9,256,852 B1 teaches about an automated package delivery system including a vehicle with a locker, wherein the delivery of package through an automated vehicle gets the route information for the next destination. It also describes an access control for a secure compartment. U.S. Pat. No. 9,122,693 B2 teaches about drawing a bounded area (polygon of points) that defines the location where the user has been for a sustained period of time. Each of the boundary points is the center of a cluster of points that the user has been at.

US 20130159207 describes identifying a location in a package and mail delivery system. It further describes dividing the Earth's surface into a grid system assigning the position of the location coordinate, and then further dividing the grid into increasingly smaller grid units until a precise identifier is determined for the input location coordinate. U.S. Pat. No. 8,731,823 talks about advanced map information delivery, processing and updating. This patent talks about the method of refreshing map tiles on a vehicle device based on new tiles that are sent by the server and storing them on the vehicle device. This describes GPS map tile updates for updated data on the server. U.S. Pat. No. 6,408,243 B1 is yet another example of a Service Delivery System. US 20160148268 teaches restricting the delivery of goods to within a defined delivery grid.

In view of the above prior art, there is a need to evolve an actionable intelligence in case of maps and delivery of commodities/goods in a supply-chain mechanism. There is no reference in the prior art where map context parameters are defined and used for the supply chain. Secondly there is no mention or reference of historically similar data being used to guide the development of delivery grid within a map for a business problem. Thirdly, there is no mention of adaptive nature of developing delivery grids for supply-chain.

### SUMMARY OF THE INVENTION

The present disclosure describes systems and a method for evolving a context cognitive cartographic grid for a map using at least one geocoding parameter and at least one parameter selected from a set comprising pre-defined context parameters and historical data.

In an exemplary mode for the disclosure, for a given map, the context cognitive cartographic grid is created using various steps. This could be also be a system or/and also on a computer readable medium configured to implement the exemplary steps.

As per one aspect of the disclosure, if there is a reference geolocation then that is taken as a starting point for traversing various routes emanating from the reference geolocation. If there is no reference geolocation, then a user defined pointer of geocode on the map is taken as the starting point for further steps.

According to another aspect of the disclosure, using pre-defined context parameters, a second geolocation is selected or updated. In a further exemplary mode, for this step, historical data of grids could also be used. The second geolocation is stored in a repository. Along with it, if the reference geolocation is available, it is also stored in the repository. The process is repeated until all the possible routes associated with the identified reference geo-location are traversed. Subsequently, a convex grid is created using all the geolocations found to evolve the context cognitive cartographic grid.

As per yet another aspect of the disclosure, pre-defined context parameters in an exemplary manner are traffic-corrected time or distance between two geolocations based on topography and time of the day and day of the year corrected traffic parameters. In an exemplary mode, Historical Data includes cartographic data grid or grid parameters obtained from contextually similar purposes.

### BRIEF DESCRIPTION OF THE DRAWINGS

For a more complete understanding of the present invention and the advantages thereof, reference is now made to the following descriptions taken in connection with the accompanying drawings in which:

FIG. 1 describes a system 100 configured for evolving a context cognitive cartographic grid for a map;

FIG. 2 depicts a flow chart 200 for a method corresponding to the system 100, to evolve a context cognitive cartographic grid for a map, in which one or more steps of the logic flow can be mapped to various system blocks of system 100 of FIG. 1;

FIG. 3 depicts an exemplary implementation 300 of the method of flow chart 200 described in FIG. 2, evolving a context cognitive cartographic grid for a map, for a supply chain example; and

FIG. 4 depicts a system 400 with a memory and a processor configured to evolve a context cognitive cartographic grid for a map, wherein the memory and the processor are functionally coupled to each other.

### DETAILED DESCRIPTION

The present disclosure describes a system and method for evolving a context cognitive cartographic grid for a map using at least one geocoding parameter and at least one parameter selected from a set comprising pre-defined context parameters and historical data.

The system could also be a computer readable medium, functionally coupled to a memory, where the computer readable medium is configured to implement the exemplary steps of the method. The system can be implemented as a stand-alone solution, as a Software-as-a-Service (SaaS) model or a cloud solution or any combination thereof.

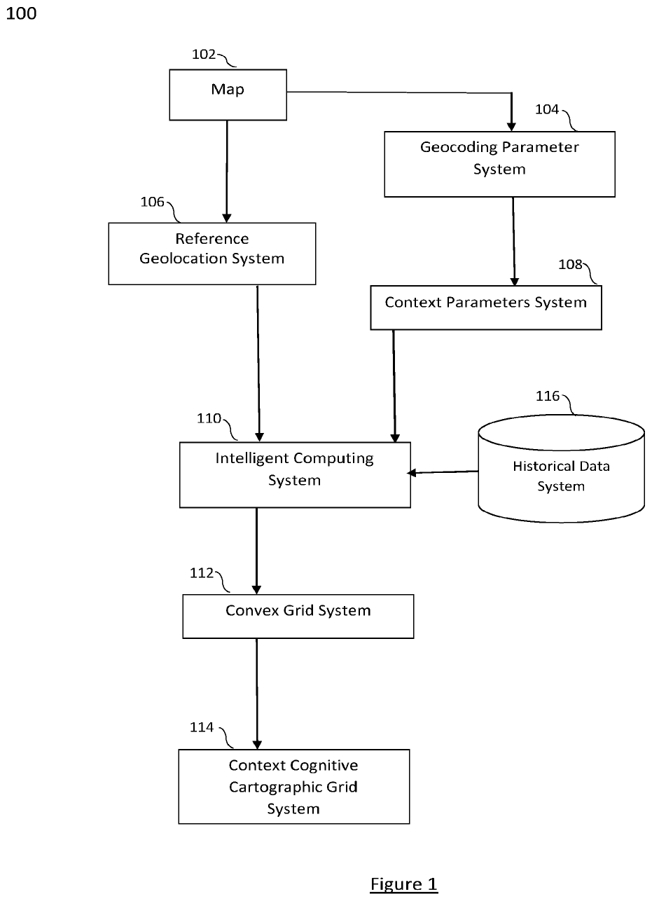

FIG. 1 describes a system (100) for evolving a context cognitive cartographic grid for a map (102). The system (100) includes the map (102) and a geocoding parameter system (104) for storing a geocoding parameter associated with the map (102). The system (100) further includes a reference geolocation system (106) which is used to store a reference geolocation associated with the map (102). The system (100) further includes a context parameters system (108) that stores a plurality of predefined context parameters which are associated with the geocoding parameter system (104). The system (100) also includes an intelligent computing system (110) which is used for iteratively traversing routes within the map (102), wherein the routes are valid paths, until all feasible routes are used, routes originating from the reference geolocation. The iterative traversal is used to evolve a plurality of second geolocations within the map (102) using the plurality of predefined context parameters and the geocoding parameter. This evolved plurality of second geolocations and the reference geolocation are stored and used to evolve a convex grid and is done in a convex grid system (112) and subsequently this convex grid is used by a context cognitive cartographic grid system (114) along with the map (102) to evolve the context cognitive cartographic grid for the map (102).

The system (100) further includes a historical data system (116) storing at least one selected from the set comprising the geocoding parameter, the reference geolocation, the plurality of pre-defined context parameters and corresponding context cognitive cartographic grid for the map (102) obtained from contextually similar application purposes, wherein the historical data system (116) is functionally coupled to the intelligent computing system (110).

In an exemplary manner, the geocoding parameter is time and the plurality of pre-defined context parameters comprise traffic-corrected time or distance between two geolocations of the route based on topography of the map (102), time of the day and day of the year corrected traffic parameters related to the route. In an exemplary manner, the intelligent computing system (110) computes correlations between reference geolocation, the plurality of second geolocations, the plurality of pre-defined context parameters and the geocoding parameter using methods selected from statistical methods, numerical methods, expert systems based methods, artificial intelligence based methods, machine learning methods and any combination thereof.

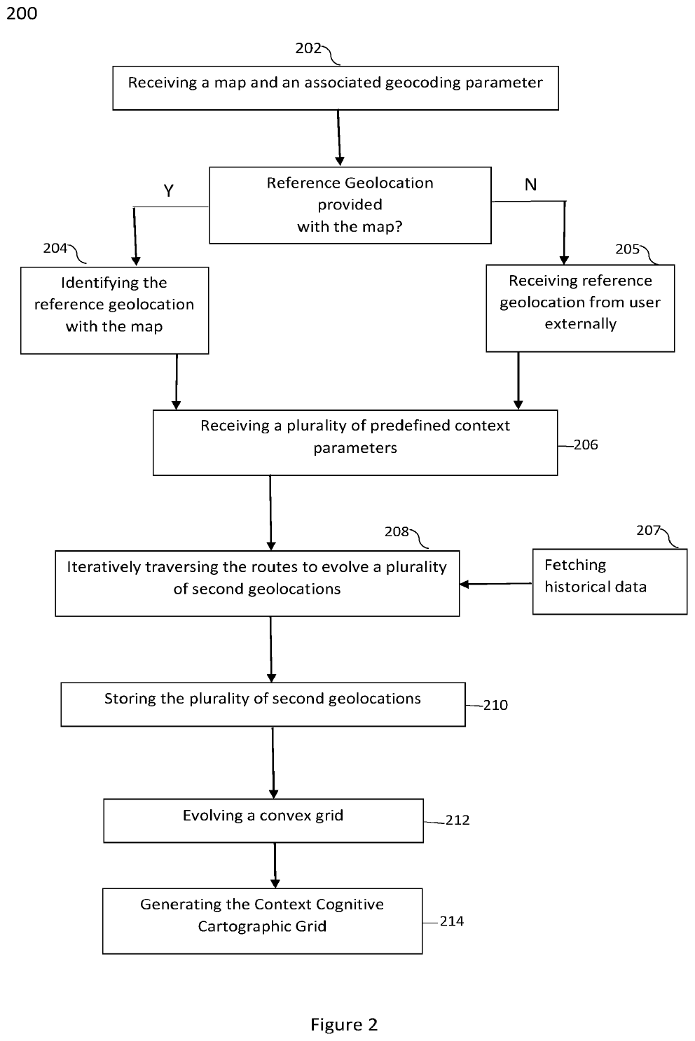

We now refer to FIG. 2 which describes a flowchart for various steps of a method (200) to evolve a context cognitive cartographic grid for a map, in which various one or more steps of the logic flow can be mapped to various system blocks of system (100) of FIG. 1. Thus this method (200) is consistent with the system (100) described in FIG. 1, and is explained in conjunction with components of the system (100). Step (202) describes receiving the map (102) and a geocoding parameter associated with the map (102). Step (204) then describes identifying a reference geolocation within the map (102). The geolocation could be a center of the map as example. If the reference location is already not provided with the map (102), step (205) describes receiving the reference geolocation associated with the map (102) from a user externally and separately. After having obtained the reference geolocation, either with the map or from the user, corresponding to the geocoding parameter, step (206) describes receiving a plurality of pre-defined context parameters, where the plurality of pre-defined context parameters is related to the geocoding parameter. Step (208) describes iteratively traversing routes within the map (102), wherein the routes are valid paths, until all feasible routes are used, originating from the reference geolocation, to evolve a plurality of second geolocations within the map (102) using the plurality of predefined context parameters and the geocoding parameter. Step (210) then describes storing the evolved plurality of second geolocations along with the reference geolocation. This storage could be in database—RDBMS or hierarchical. Using this plurality of second geolocations, step (212) describes evolving a convex grid and further step (214) depicts generating the context cognitive cartographic grid, using the evolved convex grid and the map (102).

Another aspect of the disclosure also describes that if there is historical data available that is from contextually similar application, then it can be used to evolve correlations between multiple variables in an adaptive manner. Step (207) describes fetching historical data from a historical data system (116) that stores at least one selected from the set comprising the geocoding parameter, the reference geolocation, the plurality of pre-defined context parameters and corresponding context cognitive cartographic grid for the map (102) obtained from contextually similar application purposes, wherein the fetched historical data is used to evolve the plurality of second geolocations.

In an exemplary manner, the geocoding parameter is time and the plurality of pre-defined context parameters may include traffic-corrected time or distance between two geolocations of the route based on topography of the map (102), time of the day and day of the year corrected traffic parameters related to the route. As another example, evolving of the convex grid uses computing of correlations between reference geolocation, the plurality of second geolocations, the plurality of pre-defined context parameters and the geocoding parameter using methods selected from statistical methods, numerical methods, expert systems based methods, artificial intelligence based methods, machine learning methods and any combination thereof.

### Example Embodiment

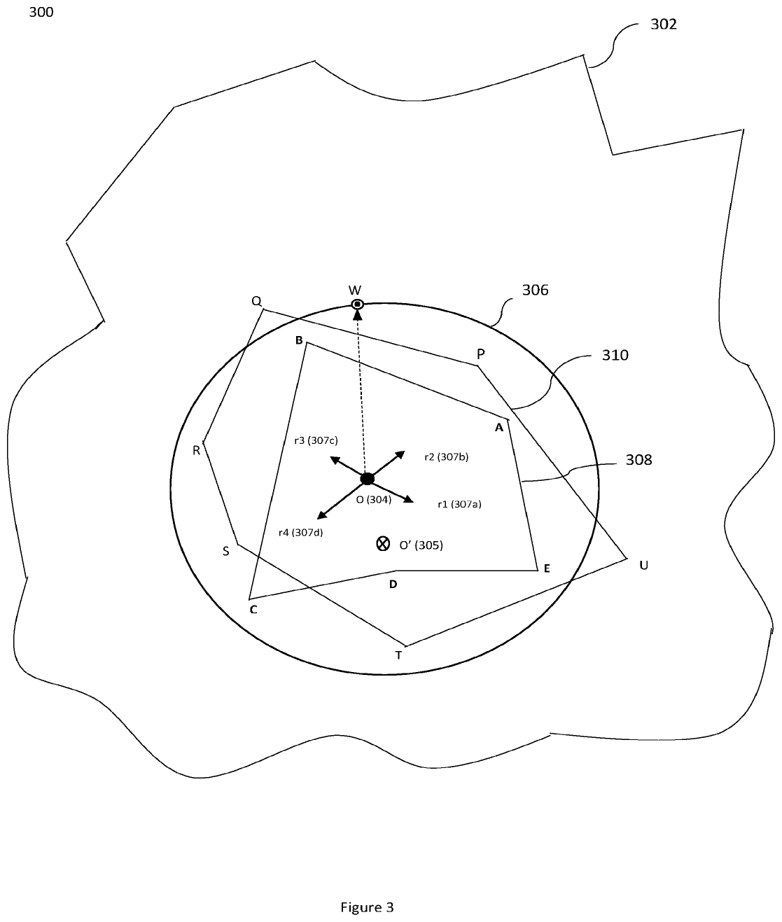

FIG. 3 depicts an exemplary implementation (300) of the method of flow chart (200) described in FIG. 2, evolving a context cognitive cartographic grid for a map, for a supply chain example.

Exemplary implementation (300) describes a food delivery system. It is important to remember that the food delivery system is only an example, and it could be any commodity being delivered in any supply-chain model. FIG. 3 shows a Map (302) of a town, corresponding to (102) of FIG. 1, and the business application is to deliver food within a stipulated time, and hence “time” is the corresponding geocoding parameter. This is corresponding to step (202). As per step (204), the map (302) also is obtained with the geographical center of the town (typically downtown area) being “O”, and is depicted as (304) in FIG. 3. The food delivery will be done from this food shop at point “O” (304) and hence is depicted as the reference geolocation. If the map (302) were to not come with a pre-defined “O” (304), then a user would be asked to provide the food shop location at the downtown and that would be termed as “O′” (305)—the reference geolocation. This is corresponding to step (205).

We will continue our exemplary embodiment with “O” (304) as the reference geolocation. A plurality of predefined context parameters is obtained as per step (206). The plurality of predefined context parameters includes but is not limited to: traffic-corrected time or distance between the reference geolocation “O” (304) and any other geolocations of the route based on topography of the map (302), time of the day and day of the year corrected traffic parameters related to the route on the map (302). As per the exemplary embodiment, one can easily think of drawing a circle with average estimated speed of 30 mph in the city center and taking time (geocoding parameter)=45 min, as maximum delivery time acceptable for piping hot food. This is depicted as (306). This circle (306) indicates a circle with radius, indicated by OW. With a dotted line, equal to average distance calculated from average speed (30 mph)*45 min, within which the food shop will be able to take orders from and still guarantee hot food delivery within 45 minutes.

However, what happens in reality is that depending on the routes and the road conditions of the routes emanating from the food shop located at “O” (304), the time of the day and the day of the week, the actual distance that the delivery-person can travel (also will depend on his/her own vehicle—two wheeler/car etc.) can vary drastically. It will also be a function of traffic and other traffic related conditions. There are also changes in the traffic and road conditions depending on the season. All of these are predefined context parameters. These are related to the geocoding parameter—time, in this case.

Elaborating further on the predefined context parameters, it is important to note that the plurality of predefined context parameters may include a combination of parameters. In an exemplary manner, the predefined context parameters may also include perceived lost business or recorded lost business driven relaxation of geocoding parameter.

For map (302), let there be, in an exemplary manner, a set of four routes (307) individual routes indicated by r1 (307a), r2 (307b), r3 (307c), and r4 (307d), emanating from the reference geolocation “O” (304). Corresponding to the Step (208), taking “O” (304) as the first geolocation, iteratively traversing all four routes within the map (102), wherein the routes are valid paths, r1 (307a), r2 (307b), r3 (307c), and r4 (307d), until such time that we are within the boundary of the map (302) and still within 45 minute time window, we arrive at A, B, C, D and E as set of second geolocations. This is for time at 7 pm and for a Friday. This has assumed traffic data obtained or projected data obtained from any available mapping tools/GPS tools etc. Step (210) corresponds to storing the data of points A, B, C D and E along with the reference geolocation “O” (304). Connecting A-B-C-D and to E so as to make it into a convex grid is corresponding to step (212) of FIG. 2. Then subsequently associating it with the map (302) along with shading to reflect predefined context parameters to show as context cognitive cartographic grid (308) is corresponding to step (214) of FIG. 2.

If we were to evolve and store the convex grid for different set of predefined context parameters, in an exemplary manner, for say Saturday 1 pm, when the traffic is supposed to be/seen to be sparse, using the same reference geolocation “O” (304) and same routes r1 (307a), r2 (307b), r3 (307c), and r4 (307d), until such time that we are within the boundary of the map (302) and still within 45 minute time window; we arrive at P, Q, R, S, T and U as yet another set of second geolocations. This is for time at 1 μm and for a Saturday. This has assumed traffic data obtained or projected data obtained from any available mapping tools/GPS tools etc. Step 210 corresponds to storing the data of points P, Q, R, S, T and U along with the reference geolocation “O” (304). Connecting P-Q-R-S-T and to U, so as to make it into a convex grid is corresponding to step (212) of FIG. 2. Then subsequently associating it with the map (302) along with different shading to reflect different predefined context parameters to show as context cognitive cartographic grid (310) is corresponding to step (214) of FIG. 2.

If we assume that we do not have access to real time traffic data for a particular time slot in the future we are making predictions for, we can still use the historical data stored for the same commodity—in this case food or for that matter any other commodity—even as unrelated as parcels, to gauge the predefined context parameters, which is in an exemplary manner contextually similar purpose. This is done corresponding to step (207) of FIG. 2, where we fetch historical data from a historical data system (116) that stores at least one selected from the set comprising the geocoding parameter, the reference geolocation, the plurality of pre-defined context parameters and corresponding context cognitive cartographic grid for the map (302) obtained from contextually similar application purposes, wherein the fetched historical data is used to evolve the plurality of second geolocations.

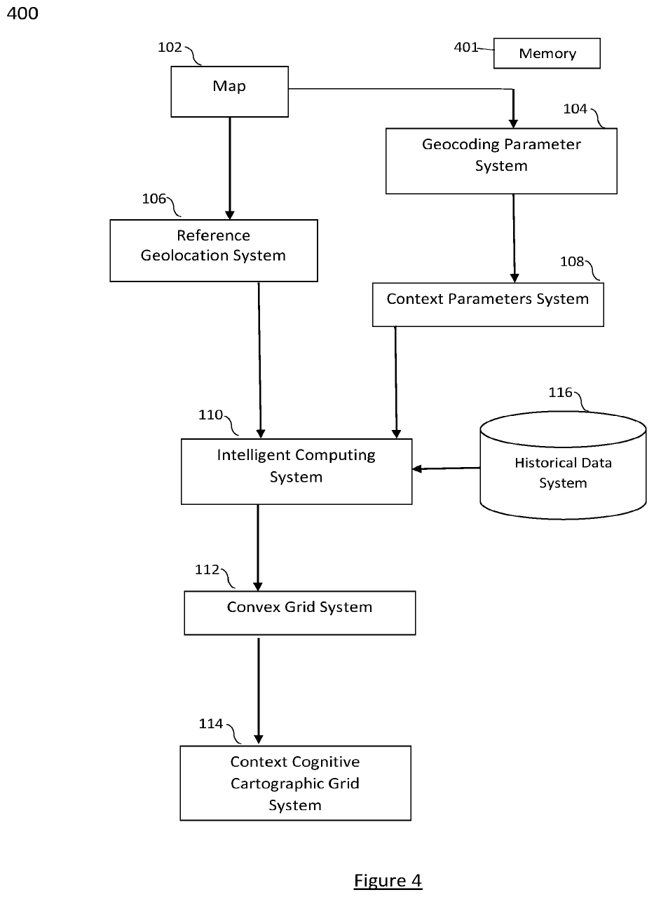

FIG. 4 depicts a system 400 with a memory and a processor configured to evolve a context cognitive cartographic grid for a map, wherein the memory and the processor are functionally coupled to each other.

The system (400) includes the map (102) and the geocoding parameter system (104) storing a geocoding parameter associated with the map (102) and also the reference geolocation system (106) storing a reference geolocation associated with the map (102). The system 400 further includes the context parameters system (108) that stores a plurality of predefined context parameters wherein the context parameters system (108) is associated with the geocoding parameter system (104). The system 400 further includes the intelligent computing system (110) for iteratively traversing routes within the map (102), wherein the routes are valid paths, until all feasible routes are used, originating from the reference geolocation, to evolve a plurality of second geolocations within the map (102) using the plurality of predefined context parameters and the geocoding parameter. The system 400 also further includes the convex grid system (112) that uses the evolved plurality of second geolocations along with the reference geolocation and further the context cognitive cartographic grid system (114) that uses the convex grid obtained in the convex grid system (112) and the map (102), and wherein the context cognitive cartographic grid system is functionally coupled to the processor.

Thus, the systems (100) and (400) and the method (200) in accordance with the present disclosure are deployable across a plurality of platforms using heterogeneous server and storage farms spread across geographies for better availability and high response time.

The systems (100) and (400) and the method (200) are deployable using multiple hardware and integration options, such as, for example, cloud infrastructure, standalone solutions mounted on mobile hardware devices, third-party platforms and system solutions etc. and is advantageously facilitated to be validated using biometric and electronic verifications like e-KYC (Know Your Customer).

There are several advantages of the system and method of evolving a context cognitive cartographic grid for a map proposed in the disclosure. One advantage is that the system and method include various context aware inputs to draw the cartographic grid over simple distance based methodologies. Context aware inputs increase the efficiency and reliability of drawing grids.

Yet another advantage is that the use of historical data reduces computation and draws upon optimal designs already created for similar business purposes.

1-10. (canceled)

11. A system for planning delivery from a reference location, the system comprising:
a memory storing: (i) a map of a region that includes the reference location, (ii) a geocoding parameter associated with the map, wherein the geocoding parameter indicates a constraint which needs to be satisfied when delivering a commodity from the reference location, and (iii) a plurality of predefined context parameters associated with different points in time at which the delivery can occur, wherein each predefined context parameter of the plurality of predefined context parameters indicates how quickly a delivery person can travel between locations in the map at a respective point in time associated with the predefined context parameter;
a processor configured to:
determine, based on the map, a plurality of routes originating from the reference location;
determine a set of additional locations in the map which are reached from the reference location based on traversal of the plurality of routes at a point in time which is one of the different points in time at which the delivery can occur, wherein the set of additional locations are reached from the reference location while satisfying the constraint indicated by the geocoding parameter, and wherein traversal of the plurality of routes is determined based on a predefined context parameter of the plurality of predefined context parameters which is associated with the point in time;
determine a sub-region in the map which is defined by a polygon that connects the set of additional locations; and
store the sub-region in the memory in a manner that associates the sub-region with the map and with a shading for identifying the sub-region, so as to enable the sub-region to be shown with the shading on the map.

12. The system of claim 11, wherein the constraint indicated by the geocoding parameter is a time window in which the delivery of the commodity needs to occur.

13. The system of claim 11, wherein the plurality of predefined context parameters are associated with different times of day or different days of week at which the delivery can occur.

14. The system of claim 13, wherein each predefined context parameter of the plurality of predefined context parameters defines a traffic-corrected time, which is an amount of time that will be spent traveling from the reference location to another location on one of the routes under a traffic condition for a time of day or day of week associated with the predefined context parameter.

15. The system of claim 14, wherein the processor is configured to determine the traffic-corrected time further based on topography of the map.

16. The system of claim 13, wherein each predefined context parameter of the plurality of predefined context parameters defines a traffic-corrected distance, which is a distance that can be traveled on one of the routes in a time window under a traffic condition for a time of day or day of week associated with the predefined context parameter.

17. The system of claim 13, wherein the plurality of predefined context parameters are based on projected traffic data.

18. The system of claim 11, wherein the traversal of the plurality of routes is a first traversal of the plurality of routes, wherein and the point in time associated with the first traversal is a first point in time, wherein the set of additional locations is a first set of additional locations, and wherein the sub-region and the shading are a first sub-region and a first shading, respectively, and wherein the processor is further configured to:
determine a second set of additional locations in the map which are reached from the reference location based on a second traversal of the plurality of routes at a second point in time which is one of the different points in time at which the delivery can occur, the second point in time being different than the first point in time, wherein the second set of additional locations are reached while satisfying the constraint indicated by the geocoding parameter, and wherein the second traversal is determined based on another predefined context parameter of the plurality of predefined context parameters which is associated with the second point in time;
determine a second sub-region in the map which is defined by another polygon that connects the second set of additional locations; and
store the second sub-region in the memory in a manner which associates the second sub-region with the map and with a second shading for identifying the second sub-region.

19. The system of claim 11, wherein the processor is configured to determine the set of additional locations based on historical data.

20. The system of claim 11, wherein the memory and the processor are part of a mobile device or part of cloud-based infrastructure.

21. A method for facilitating planning of delivery from a reference location, the method the system comprising:
determining, based on a map of a region that includes the reference location, a plurality of routes originating from the reference location, wherein the map stores the map and further stores a geocoding parameter associated with the map and stores a plurality of predefined context parameters associated with different points in time at which the delivery can occur, wherein the geocoding parameter indicates a constraint which needs to be satisfied when delivering a commodity from the reference location, and wherein each predefined context parameter of the plurality of predefined context parameters indicates how quickly a delivery person can travel between locations in the map at a respective point in time associated with the predefined context parameter;
determining a set of additional locations in the map which are reached from the reference location based on traversal of the plurality of routes at a point in time which is one of the different points in time at which the delivery can occur, wherein the set of additional locations are reached from the reference location while satisfying the constraint indicated by the geocoding parameter, and wherein traversal of the plurality of routes is determined based on a predefined context parameter of the plurality of predefined context parameters which is associated with the point in time;
determining a sub-region in the map which is defined by a polygon that connects the set of additional locations; and
storing the sub-region in the memory in a manner that associates the sub-region with the map and with a shading for identifying the sub-region, so as to enable the sub-region to be shown with the shading on the map.
